(19) United States
(12) Patent Application Publication
(10) Pub. No.: US 2024/0385907 A1
(43) Pub. Date: Nov. 21, 2024

(54) MANAGEMENT CONTROL PLANE FOR INSTANCE OF AN OMNICHANNEL CLOUD-BASED CONTACT CENTER

(71) Applicant: Twilio Inc., San Francisco, CA (US)

(72) Inventors: Asko Tiidumaa, San Francisco, CA (US); Teemu Suutari, San Francisco, CA (US)

(21) Appl. No.: 18/198,808

(22) Filed: May 17, 2023

(51) Int. Cl. G06F 9/54; G06F 9/451

(52) U.S. Cl. CPC G06F 9/541; G06F 9/451; G06Q 30/01

(57) ABSTRACT

Described herein is a management control plane for a cloud-based contact center service. The management control plane includes a descriptive model and a user interface for configuring individual instances of the contact center service for use by a customer. The descriptive model provides a unified representation of all of the configuration settings for all integrated services comprising the contact center service. When instantiating a configured instance of the contact center service, a configuration process will communicate the appropriate configuration settings to each integrated service, for the instance, and return a configuration status. The configuration settings and the configuration status of each integrated service are stored in a version-controlled manner, so that subsequent configuration changes may be rolled back if problems occur.

### TECHNICAL FIELD

The present application generally relates to a management control plane for configuring, creating, and updating individual instances of a cloud-based omnichannel customer interaction system (e.g., a contact center system).

### BACKGROUND

A cloud-based omnichannel customer interaction system, also referred to as a omnichannel contact center service leverages service integration to seamlessly connect and integrate various communication channels such as video, voice, email, chat, social media, and more into a unified platform or service. This contact center solution enables individual enterprise customers to have their own highly flexible and configurable instances of the contact center service tailored to their specific needs. Through service integration, the contact center service can integrate with customer relationship management (CRM) systems, telephony infrastructure, messaging infrastructure, workforce management tools, and other applications, allowing for smooth data exchange and process automation. This integration empowers customers to configure their contact center instance with personalized settings, routing rules, agent workflows, reporting metrics, and other customizations, while still benefiting from the core features and capabilities provided by the cloud-based contact center service.

### BRIEF DESCRIPTION OF THE DRAWINGS

Embodiments of the present invention are illustrated by way of example and not limitation in the figures of the accompanying drawings, in which:

FIG. 1 is a diagram illustrating a conventional contact center platform or service, for which various external services need to be separately configured in order to deploy a single instance of the service.

FIG. 2 is a diagram illustrating an improved contact center service with a management control plane, consistent with some embodiments.

FIG. 3 is a timing diagram illustrating how changes may be made to a version controlled descriptive model, used in the instantiation of individual instances of the contact center service, consistent with some embodiments.

FIG. 4 is a diagrammatic representation of a computing device (e.g., a machine) within which instructions for causing the computing device to perform any one or more of the methodologies discussed herein may be stored and executed.

FIG. 5 is a block diagram illustrating a software architecture, which can be installed on any one or more of the devices described herein.

### DETAILED DESCRIPTION

Described herein is a software-based management control plane for configuring and creating individual instances of a cloud-based omnichannel contact center service. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

In a cloud-based application or service, multiple individual services may be “tied” together to behave as one cohesive application service through a process called service integration. Service integration involves connecting different services and applications together in order to create a cohesive and integrated application or service. In the context of an application or service offered as a Software as a Service (Saas) solution, the service provider typically offers a set of core services or functionalities that are shared among all enterprise customers. These services can include user authentication, data storage, processing capabilities, and access to specific features or application programming interfaces (APIs). Service integration in a SaaS solution involves configuring and connecting these core services in a way that meets the requirements of each individual enterprise customer. This can be a complex task, especially when different enterprise customers have unique needs, preferences, or specific configurations.

One of the challenges in configuring different instances for different enterprise customers lies in customization. Each enterprise customer may have specific settings, preferences, or configurations that need to be applied to their instance of the service. This can include custom branding, user permissions, data access rules, integration with external systems, and more. To address this challenge, SaaS providers often adopt a multi-tenancy architecture. In a multi-tenant SaaS environment, a single instance of the software serves multiple customers, but each customer's data and configuration are logically isolated from one another. This allows for efficient resource utilization and scalability.

However, managing and maintaining these custom configurations for different instances can be a complex task for the provider, as it requires robust infrastructure, security measures, and careful management of customer-specific configurations. Additionally, ensuring the seamless functioning of the shared core services across all instances while accommodating customer-specific configurations can pose technical challenges for the provider.

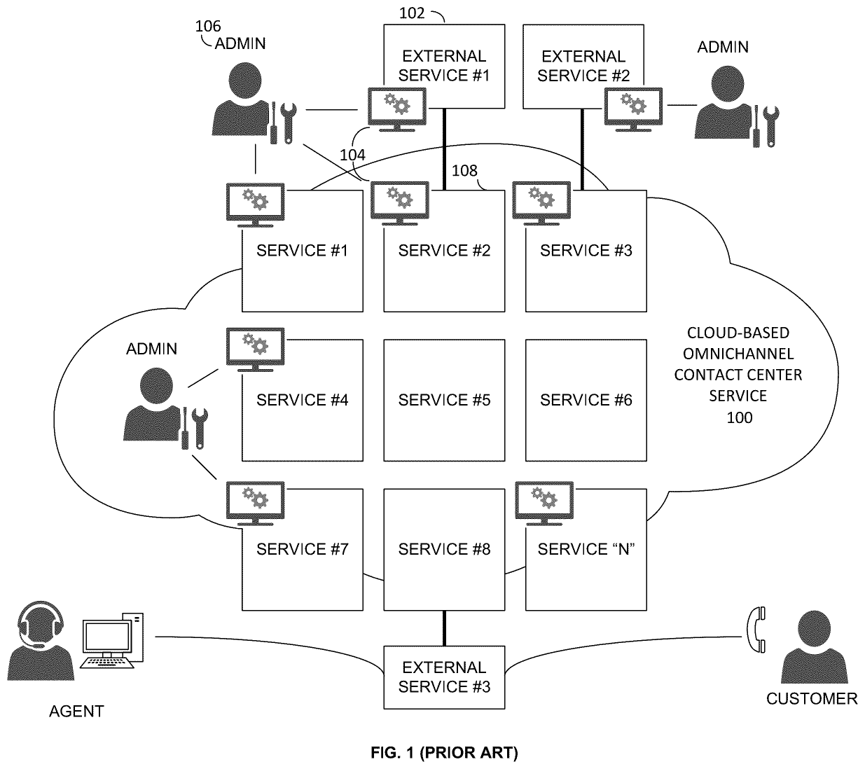

FIG. 1 is a diagram illustrating a conventional contact center platform or service 100, for which various integrated services need to be separately configured in order to deploy a single instance of the contact center service for one enterprise customer. For purposes of this disclosure, each independent service that operates together to form the contact center service is referred to as an integrated service. As shown in FIG. 1, a cloud-based contact center service 100 may include a large number of individual integrated services. Some of these integrated services may be owned and controlled by the service provider, whereas other integrated services may be owned and controlled by other entities. In FIG. 1, the integrated services under the control of other entities are labeled as external services, such as the external integrated service 102 labeled as “EXTERNAL SERVICE #1”.

As shown in FIG. 1, the individual integrated services with the gear icon 104 (e.g., the display with gears) are highly configurable, such that they require a user (e.g., an administrator) to specify various configuration values for different configuration settings, so that the integrated service will operate in a preferred manner for each customer's instance. In many cases, the configuration of the integrated service must be done by a person, for example, an end-user or administrator of the service provider. That is, the configuration settings may not be accessible to a person (a user or administrator) associated with the enterprise customer. As shown in FIG. 1, some of the integrated services may have no, or very limited, configuration requirements. For instance, those integrated services without the gear icon 104 have no configuration requirements.

With a cloud-based omnichannel contact center service 100, an individual integrated service may be deployed to provide each individual communication channel of a variety of communication channels. Accordingly, an integrated service may facilitate or otherwise support a video communication channel, a voice communication channel, a webchat channel, an SMS messaging channel, an email channel, a social media channel, and so forth. Each of these communication channels may be a separate integrated service with its own configuration settings that allow the individual communication channel to be customized in some way. For example, each enterprise customer may request that a voice channel be configured with customer-specific telephone numbers. Similarly, each enterprise customer may request that an integrated service for an email channel be configured with one or more customer-specific domain names and email addresses, and so forth.

Generally, some of the other types of integrated services that may be deployed with a cloud-based contact center service include:
An integrated service for providing communication or task routing (e.g., routing customer requests to agents).
An integrated service providing an interactive voice response service for use with a voice channel.
An integrated service for connecting with a customer relationship management (CRM) service or a customer data platform (CDP) for accessing customer data.
A workflow or workforce management service for scheduling tasks and ensuring that specific work items are completed in order.
An integrated service providing reporting and analytics features and for generating customer insights.
An integrated service for authenticating end-users (e.g., agents or representatives, customers, and so on).

This is of course a non-exhaustive list of just some of the many different types of integrated services that may be part of a cloud-based contact center service. In many cases, some of the specific types of integrated services referenced herein may have more than one specific integrated service offering. For example, the contact center service may be designed so that each enterprise customer can enable a specific voice communication channel, or messaging service of the enterprise customer's choosing. Those skilled in the art will readily appreciate that many other integrated services-some of which are highly customizable with different configuration settings—may be included with a cloud-based contact center service.

In order to instantiate a single instance of the contact center service for one enterprise customer, many independent integrated services may need to be separately configured. In some cases, each independent integrated service may have its own team of software developers or service administrators who are responsible for developing, maintaining, and configuring the integrated service. For example, as shown in FIG. 1, a first administrator 106 may be responsible for configuring a first integrated service 108 and a second external integrated service 102, so that for any one instance, the two services 102 and 108 operate together in a desired way. Similarly, another administrator 110 may be responsible for configurating two integrated services 112 and 114 to operate together in a preferred manner. Accordingly, one of the difficulties of instantiating an instance of a cloud-based contact center service that has several integrated services is that it may require communicating with a number of team members—each responsible for configuring one or more specific integrated services- and this may take a significant amount of time.

Another problem that frequently arises in this context is that various integrated services may change over time. As various integrated services evolve to add new features and functionality-specifically, external services that are beyond the control of the service provider- and, as entirely new integrated services are added, enterprise customers may want to change or upgrade the configuration of their specific instance to leverage these new services and/or the new features and functionality. Under the current configuration scheme as represented in FIG. 1, this may require administrators or software developers from the service provider to access an enterprise customer account in order to execute scripts that make configuration updates or changes to an integrated service. This is less than ideal. If something goes wrong, there is no mechanism in place to easily roll back the changes that have resulted from the execution of the configuration scripts. In turn, this may lead to significant time and effort in trouble shooting and debugging, and so forth.

Consistent with some embodiments of the present invention, a software-based management control plane is deployed with an omnichannel contact center service. The management control plane provides the enterprise customer with a self-servicing solution to configure all of the integrated services from a single user interface before requesting the instantiation of an instance of the contact center service. Furthermore, a version-controlled descriptive model is used to represent the configuration capabilities of the contact service center at any specific time. As any one integrated service is updated or modified over time, or as an integrated service is added to or removed from the contact center service, the version-controlled descriptive model is updated to reflect the changes to the currently configurable capabilities of the contact center service. Accordingly, when an enterprise customer instantiates an instance of the contact center service, the version of the descriptive model is included in an instance configuration record for the specific instance of the enterprise customer. If the enterprise customer subsequently attempts to reconfigure and update the instance based on a new version of the descriptive model, if any problems occur as a result of the update, the instance can be reconfigured (e.g., rolled back) to a known and stable configuration using the configuration settings in the instance configuration record from a prior version of the descriptive model. Several other aspects and advantages of the present invention will be readily apparent to those skilled in the art from the description of the several figures that follows.

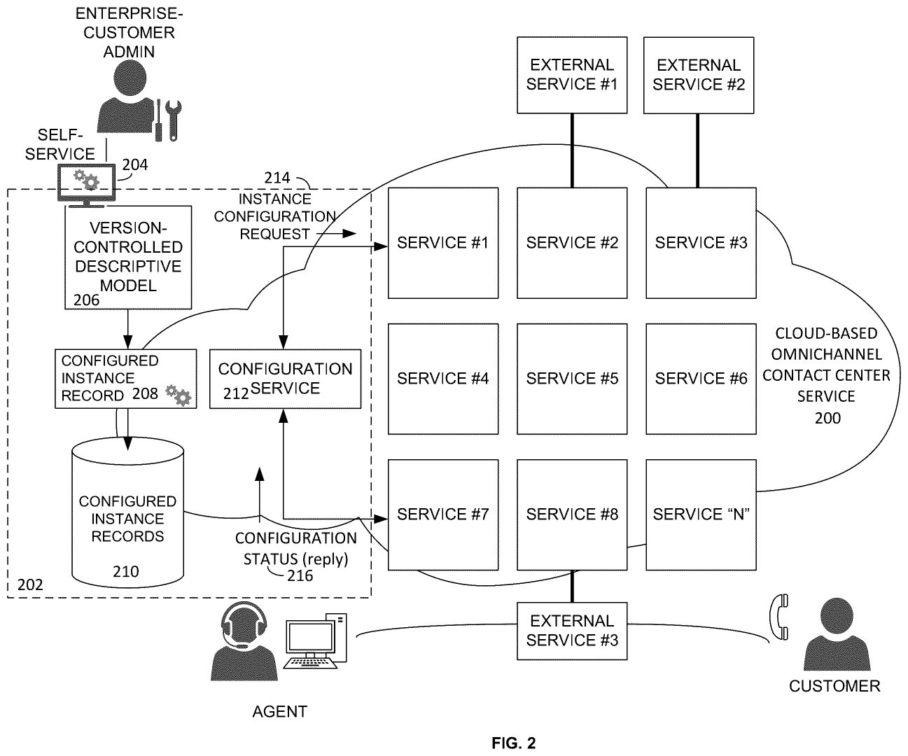

FIG. 2 is a diagram illustrating an improved contact center service 200 with a management control plane 202, consistent with some embodiments. The management control plane 202 is comprised of a user interface 204 via which an enterprise customer is able to configure and instantiate an instance of the contact center service 200. Consistent with some embodiments, the user interface 204 may be a web-based interface, where configuration settings may be organized and grouped by their respective integrated service, or by channel or by some other functionality or categorization. For purposes of the present disclosure, the user interface 204 may comprise a single web page or multiple related web pages, where each web page displays a group of related configuration settings. With some alternative embodiments, the user interface may also be provided via an application that may be a native application or platform-specific application, such as one that is designed to execute on a specific operating system (OS), whether that is a desktop or mobile OS. Generally, the configuration settings may be specified through various user interface elements, including dropdown menus, checkboxes, radio buttons, text input fields, sliders, toggle switches, tabs or navigation panels, and so forth.

Consistent with some embodiments, the configuration settings that are exposed to an end-user associated with the enterprise customer via the user interface 204 may include only a subset of all possible configuration settings, or alternatively, may include all configuration settings for each integrated service. This may be a design choice of the service provider, who may prefer to expose a specific collection of configuration settings in order to simplify the overall contact center service in some respect. Similarly, at any given time, some configuration settings for some integrated services may be described or referenced in the descriptive model, but not yet accessible to an enterprise customer via the configuration user interface. This may be done, for example, to allow testing and development of various features and functionality of different integrated services by the service provider, prior to deploying the same to any enterprise customer's live instance. The configuration settings for each of the integrated services that are accessible via the user interface 204 are represented in the version-controlled descriptive model 206. For instance, to ensure a unified configuration experience, there should be no configuration settings for the contact center service displayed via the configuration user interface, where the configuration settings are not described or referenced in the descriptive model 206.

As shown in FIG. 2, the version-controlled descriptive model 206 is a model that represents all of the configuration settings or options of the various integrated services at a particular point in time. Accordingly, the configuration settings for the various integrated services that are exposed to the administrative end-user of the enterprise customer are based on configuration settings that are set forth in the most recent version of the version-controlled descriptive mode 206. As described in more detail below, as the contact center service evolves over time, the descriptive model 206 may be updated to reflect the addition of new, or removal of old, configuration settings for specific integrated services. Similarly, if entirely new integrated services are added, or if some integrated services are removed altogether—these changes to the associated configuration settings for the integrated services will be reflected in the descriptive model 206.

After an admin end-user of the enterprise customer has established or specified all of the required values for the configuration settings for a particular instance of the contact center service 200, the admin end-user will invoke a request—for example, by interacting with a user interface element (e.g., a button, or similar)—to generate an instance of the omnichannel contact center service. This will create a configured instance record 208 that persists or stores all of the various values of the configuration settings as specified by the admin end-user for a specific instance of the contact center service. The configured instance record 208 will also include an indicator of the version of the descriptive model 206 that was in use when the request to instantiate the instance was received. As such, the configured instance record 208 is essentially a copy of the version-controlled descriptive model, with all of the established configuration values for the corresponding configuration settings for the various integrated services, for a specific instance of the contact center service.

Once the configured instance record 208 has been created, a configuration service 212 will process the request to instantiate the instance of the contact center service by communicating an instance configuration request 214 to each integrated service for which configuration settings need to be applied. The relevant configuration settings for each integrated service will be communicated to the integrated service as part of the instance configuration request. This may be achieved in any of several ways. For instance, various scripts may be executed by the configuration service 212 to copy configuration settings from the configured instance record 208 to an appropriate location (e.g., a file in a folder), such that an integrated service will be able to read the relevant configuration settings from a predetermined path. In other cases, configuration settings for a specific integrated service may be communicated as part of the message payload with the instance configuration request. Each integrated service that receives an instance configuration request will process the request by self-configuring according to the received configuration settings. This, of course, may require different processing steps depending on the specific integrated service.

Consistent with some embodiments, after an integrated service has processed the instance configuration request, the integrated service will send a configuration status reply to the configuration service 212. The configuration status reply may simply indicate that the integrated service was successfully configured for the specific instance. Similarly, with some embodiments, when an error occurs during the configuration process for an integrated service, the integrated service may communicate the error to the configuration service as part of the configuration status reply.

With some embodiments, each integrated service may be programmed to determine when its capabilities have been updated. Accordingly, when an instance configuration request is received by an integrated service that has recently been updated to provide new or different features or functions-particularly when the integrated service has been modified with new or different configuration setting requirements—the integrated service may include information in the configuration status reply that indicates to the configuration service 211 that the integrated service has new capabilities, or new or different configuration settings. With some embodiments, an integrated service may be programmed to “gracefully” report back to the configuration service 212 when it has new or modified capabilities, with new or modified configuration settings. However, in other cases, an integrated service may have been updated or modified without concern for the functionality of the overall system, and as such, the configuration of the integrated service for the specific instance may simply fail. In this case, upon processing an instance configuration request, an integrated service may simply send back to the configuration service 212 a configuration status reply message that includes an error message, indicating the failure of the integrated service in successfully processing the instance configuration request.

Once all of the integrated services have processed their respective instance configuration requests and replied back to the configuration service 212, the configuration status reply for each integrated service may be written to the configured instance record 208 to memorialize the configuration status of each integrated service. Additionally one or more alerts may be generated and presented. For example, if an integrated service failed to successfully process the configuration settings and self-configure for a specific instance configuration request, an alert may be communicated to the administrator for the customer enterprise, or an administrator of the service provider. This alert may be presented via an email, a mobile notification, an administrative user interface, or any of a number of other ways. In general, the alert will identify the specific integrated service that failed to successfully self-configure, or the integrated service that has reported back to the configuration service that it has new or modified capabilities with new or modified configuration settings.

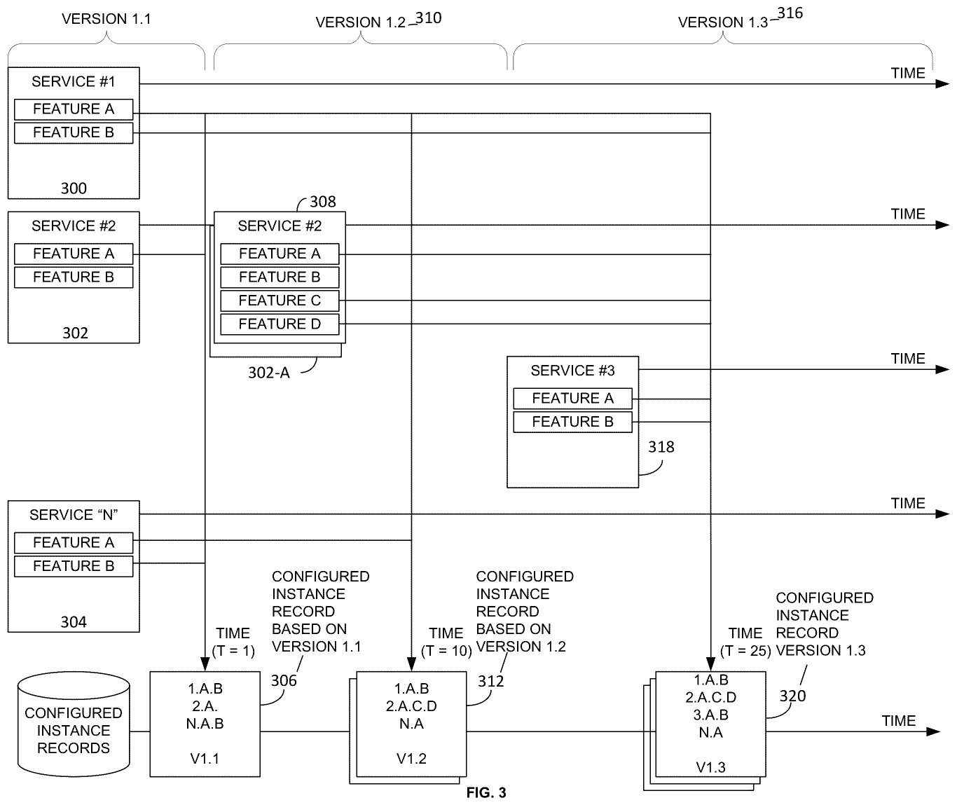

FIG. 3 is a timing diagram illustrating how changes may be made to a version-controlled descriptive model, used in the instantiation of individual instances of the contact center service, consistent with some embodiments. In FIG. 3, the boxes 300, 302 and 304 represent component parts of a first version (e.g., version 1.1) of a descriptive model. For instance, the top-most box 300 represents the configuration settings for two features-features A and B—for the service identified here as “SERVICE #1.” Similarly, the middle box 302 represents the configuration settings for two features-features A and B—for the service identified here as “SERVICE #2.” Finally, the bottom box 304 represents the configuration settings for two features-features A and B—for the service identified here as “SERVICE ‘N’”.

At a particular point in time (e.g., Time T=1), an enterprise customer instantiates an instance of the contact center service, and the configured instance record 306 is created. As shown by this example, the configured instance record 306 indicates that features A and B of the first service are enabled, as well as feature A of the second service, and features A and B of the final service “N”. In this simplified example, the presence of the service and features in the instance configuration record may simply represent that the feature for that respective service has been enabled. However, one skilled in the art will readily appreciate that in an actual implementation of the contact center service, the configuration settings will provide for a variety of custom behaviors for each integrated service, beyond simply enabling or disabling a service or feature.

As time goes on, the second service (“Service #2”) is modified to include two new features-features C and D—with corresponding configuration settings. As shown by the box with reference number 308, the descriptive model is updated to reflect the additional configuration settings for the second integrated service, and the version number 310 of the descriptive model is updated to reflect that the descriptive model has been modified as a result of adding the configuration settings for the new features to the second service. Note, the first version (version 1.1) of the descriptive model is maintained, as represented by the box with reference 302-A. With some embodiments, the descriptive model may be maintained in one file, or alternatively, in multiple files, where each file corresponds with a specific integrated service. In either situation, the version of the descriptive model may be updated any time that one integrated service is updated or modified, resulting in a change to its configuration settings.

As more time goes by, the enterprise customer decides to update the instance of their contact center service. Accordingly, at some time (e.g., Time T=10), the enterprise customer modifies the currently available configuration settings as displayed or presented via the configuration user interface, and selects an option (e.g., a button) to update their instance of the contact center service. As shown in FIG. 3, this results in a new; updated configured instance record 312, which now includes a reference or indication of the version of the descriptive model upon which the instance was instantiated (e.g., “V1.2”).

As additional time passes, the service provider for the contact center service adds a new integrated service (e.g., “SERVICE #3”) 314. The addition of this service 314 results in an update to the version of the descriptive model (e.g., version 1.3) 316. Once again, (e.g., Time T=25) the enterprise customer decides to update the configuration of their instance, in this case, by adding the features associated with features A and B of the new service (e.g., “SERVICE #3”) 318. When the enterprise customer invokes the request to update the instance, a new configured instance record 320 is generated, and this new record 320 includes all of the relevant values for the relevant configuration settings and an indication or reference to the version of the descriptive model (e.g., “V1.3”) that was used to update the instance.

As one skilled in the art will readily appreciate, one of the significant advantages that arises from the technique described herein is the ability to roll-back an instance of the contact center service, for example, if an update of an instance results in technical issues or problems. For example, at least with some embodiments, because the configured instance record identifies the version of the descriptive model that was in place at the time an instance was instantiated, the appropriate version of the descriptive model can be identified and re-used when rolling back an instance of the contact center service from one that is based on a newer version of the descriptive model.

Consistent with some embodiments, there may be multiple descriptive models (e.g., different editions or templates), where each descriptive model edition includes configuration settings and corresponding configuration values that may be used to instantiate a specific instance of the contact center service with some predetermined behaviors or characteristics. For instance, there may be several descriptive model editions, where each edition represents a common configuration for the contact center service. For example, it may be the case that some large percentage of customers tend to enable or disable the same or some similar groups of integrated services, or configure specific groups of integrated services in the same or a similar manner. By way of example, it may be the case that many enterprise customers enable three specific communication channels, and only three communication channels-voice, webchat, and email. Accordingly, a first edition of the descriptive model may be provided with several of the configuration settings for various integrated services having default configuration values. This would allow the enterprise customer to select one edition of the descriptive model that best matches or suits their needs, and quickly provide any remaining configuration settings before instantiating an instance of the contact center service.

### Machine Architecture

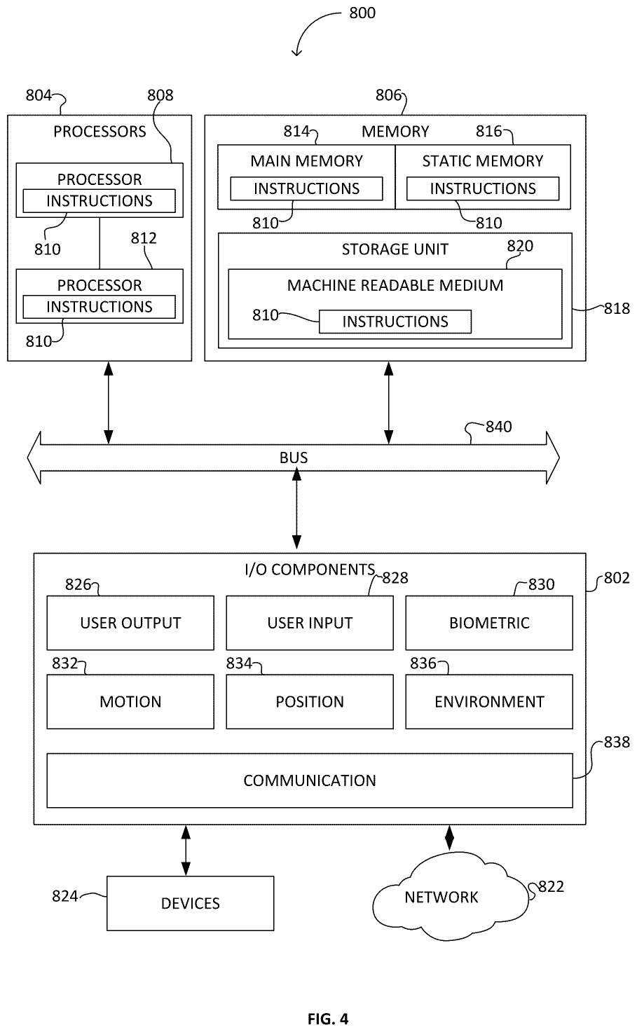

FIG. 4 is a diagrammatic representation of a machine 800—sometimes referred to as a computing device-within which instructions 810 (e.g., software, a program, an application or app, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800) into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine (e.g., client computing device) in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while a single machine 800 is illustrated, the term “machine” shall also be taken to include a collection of machines that individually or jointly execute the instructions 810 to perform any one or more of the methodologies discussed herein. The machine 800, for example, may comprise the client machine(s) or any one of multiple server devices forming part of a contact center system or service. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 802, which may be configured to communicate with each other via a bus 840. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 4 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 814, a static memory 816, and a storage unit 818, all accessible to the processors 804 via the bus 840. The main memory 806, the static memory 816, and storage unit 818 store the instructions 810 embodying any one or more of the methodologies or functions described herein. The instructions 810 may also reside, completely or partially, within the main memory 814, within the static memory 816, within machine-readable medium 820 within the storage unit 818, within at least one of the processors 804 (e.g., within the processor's cache memory), or any suitable combination thereof, during execution thereof by the machine 800.

The I/O components 802 may include a wide variety of components to receive input, provide output, produce output, transmit information, exchange information, capture measurements, and so on. The specific I/O components 802 that are included in a particular machine will depend on the type of machine. For example, portable machines such as mobile phones may include a touch input device or other such input mechanisms, while a headless server machine will likely not include such a touch input device. It will be appreciated that the I/O components 802 may include many other components that are not shown in FIG. 8. In various examples, the I/O components 802 may include user output components 826 and user input components 828. The user output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface component or another suitable device to interface with the network 822. In further examples, the communication components 838 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, location via detecting an NFC beacon signal that may indicate a particular location, and so forth.

The various memories (e.g., main memory 814, static memory 816, and memory of the processors 804) and storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

### Software Architecture

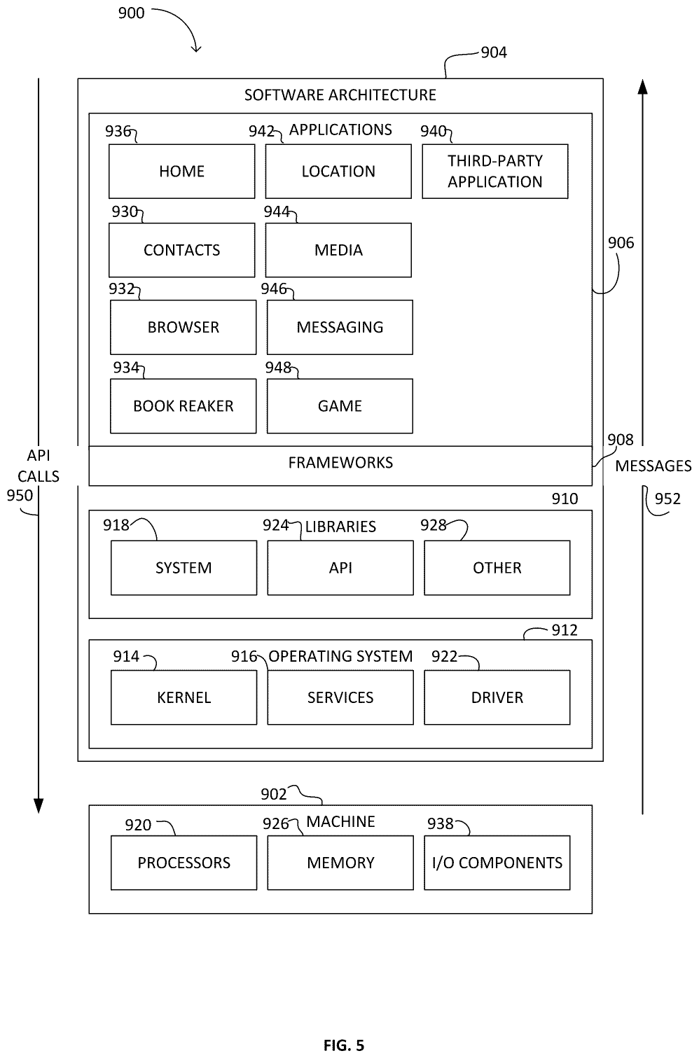

FIG. 5 is a block diagram 900 illustrating a software architecture 904, which can be installed on any one or more of the devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., USB drivers), WI-FIR drivers, audio drivers, power management drivers, and so forth.

The libraries 910 provide a common low-level infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a common high-level infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionalities described herein.

We claim:

1. A system comprising:
a processor; and
a memory storage device storing instructions thereon, which, when executed by the processor, cause the system to perform operations comprising:
causing a first user interface to be presented to a user, the first user interface presenting for each integrated service of a plurality of integrated services comprising a primary service, one or more configuration settings, wherein the one or more configuration settings for each integrated service are maintained as a version-controlled descriptive model;
receiving a request to instantiate an instance of a application service based on a specification of configuration values for the configuration settings for the plurality of integrated services as provided by the user via the user interface;
responsive to the request to instantiate the instance of the application service, communicating to each integrated service of the plurality of integrated services an instance configuration request, the instance configuration request associated with specified values for one or more configuration settings for the integrated service;
receiving from each integrated service of the plurality of integrated services a service configuration status in response to the instance configuration request; and
storing, as an instance data record for the instantiated instance of the application service, the configuration status of each integrated service, the values for the one or more configuration settings for each integrated service, and an indicator of a version of the descriptive model in use at the time of the request to instantiate the instance of the application service.

2. The system of claim 1, wherein the storage device is storing additional instructions thereon, which, when executed by the processor, cause the system to perform additional operations comprising:
receiving from a first integrated service of the plurality of integrated services a service configuration status in response to the instance configuration request, the service configuration status indicating a change in service capabilities of the first integrated service;
generating an alert to indicate the first integrated service has reported a change in service capabilities; and
causing the alert to be displayed.

3. The system of claim 1, wherein the storage device is storing additional instructions thereon, which, when executed by the processor, cause the system to perform additional operations comprising:
receiving from a first integrated service of the plurality of integrated services an error message in response to the instance configuration request;
generating an alert to indicate the first integrated service has reported the error message; and
causing the alert to be displayed.

4. The system of claim 1, wherein the instructions cause the system to perform additional operations comprising:
subsequent to the descriptive model being updated to include one or more new configuration settings for one or more new features or functions of a first integrated service of the plurality of integrated services, causing an updated user interface to be presented to a user, the updated user interface presenting the one or more new configuration settings for the first integrated service;
receiving a request to update the instance of the application service based on a specification of values for the configuration settings for the plurality of integrated services, including configuration values for the one or more new configuration settings for the first integrated service;
responsive to the request to update the instance of the application service, communicating to each integrated service of the plurality of integrated services an instance configuration request, the instance configuration request including specified values for one or more configuration settings for the integrated service, including values for one or more new configuration settings for first integrated service;
receiving from each integrated service of the plurality of integrated services a service configuration status in response to the instance configuration request; and
storing, as an instance data record for the updated instance of the application service, the configuration status of each integrated service, the values for the one or more configuration settings for each integrated service and an indicator of a version of the updated descriptive model in use at the time of the request to update the instance of the application service.

5. The system of claim 1, wherein the instructions cause the system to perform additional operations comprising:
subsequent to the descriptive model being updated to include one or more new configuration settings for a new integrated service, causing an updated user interface to be presented to a user, the updated user interface presenting the one or more new configuration settings for the new integrated service;
receiving a request to update the instance of the application service based on a specification of configuration values for the configuration settings for the plurality of integrated services including configuration values for the one or more new configuration settings for the new integrated service;
responsive to the request to update the instance of the application service, communicating to each integrated service of the plurality of integrated services an instance configuration request, the instance configuration request including specified configuration values for one or more configuration settings for the integrated service, including configuration values for one or more new configuration settings for the new integrated service;
receiving from each integrated service of the plurality of integrated services a service configuration status in response to the instance configuration request; and
storing, as an instance data record for the updated instance of the application service, the configuration status of each integrated service, the configuration values for the one or more configuration settings for each integrated service and an indicator of a version of the updated descriptive model in use at the time of the request to update the instance of the application service.

6. The system of claim 1, wherein a first edition of the version-controlled descriptive model specifies a first set of configuration values for a subset of the one or more configuration settings for the plurality of integrated services; and
wherein causing the user interface to be presented to the user comprises causing the user interface to present configuration values for the subset of the one or more configuration settings for the plurality of integrated services.

7. The system of claim 1, wherein the instructions cause the system to perform additional operations comprising:
receiving a request to update the instance of the application service based on a specification of configuration values associated with a specific version of the descriptive model;
obtaining from a selected configured instance record configuration values for the one or more configuration settings of the plurality integrated services, wherein the configured instance record is selected based on the configured instance record having an indicator of a version of the descriptive model that corresponds with the specific version of the descriptive model.

8. A computer-implemented method comprising:
causing a first user interface to be presented to a user, the first user interface presenting for each integrated service of a plurality of integrated services, one or more configuration settings, wherein the one or more configuration settings for each integrated service are maintained as a version-controlled descriptive model;
receiving a request to instantiate an instance of a application service based on a specification of configuration values for the configuration settings for the plurality of integrated services as provided by the user via the user interface;
responsive to the request to instantiate the instance of the application service, communicating to each integrated service of the plurality of integrated services an instance configuration request, the instance configuration request associated with specified values for one or more configuration settings for the integrated service;
receiving from each integrated service of the plurality of integrated services a service configuration status in response to the instance configuration request; and
storing, as an instance data record for the instantiated instance of the application service, the configuration status of each integrated service, the values for the one or more configuration settings for each integrated service, and an indicator of a version of the descriptive model in use at the time of the request to instantiate the instance of the application service.

9. The computer-implemented method of claim 8, further comprising:
receiving from a first integrated service of the plurality of integrated services a service configuration status in response to the instance configuration request, the service configuration status indicating a change in service capabilities of the first integrated service;
generating an alert to indicate the first integrated service has reported a change in service capabilities; and
causing the alert to be displayed.

10. The computer-implemented method of claim 8, further comprising:
receiving from a first integrated service of the plurality of integrated services an error message in response to the instance configuration request;
generating an alert to indicate the first integrated service has reported the error message; and
causing the alert to be displayed.

11. The computer-implemented method of claim 8, further comprising:
subsequent to the descriptive model being updated to include one or more new configuration settings for one or more new features or functions of a first integrated service of the plurality of integrated services, causing an updated user interface to be presented to a user, the updated user interface presenting the one or more new configuration settings for the first integrated service;
receiving a request to update the instance of the application service based on a specification of values for the configuration settings for the plurality of integrated services, including configuration values for the one or more new configuration settings for the first integrated service;
responsive to the request to update the instance of the application service, communicating to each integrated service of the plurality of integrated services an instance configuration request, the instance configuration request including specified values for one or more configuration settings for the integrated service, including values for one or more new configuration settings for first integrated service;
receiving from each integrated service of the plurality of integrated services a service configuration status in response to the instance configuration request; and
storing, as an instance data record for the updated instance of the application service, the configuration status of each integrated service, the values for the one or more configuration settings for each integrated service and an indicator of a version of the updated descriptive model in use at the time of the request to update the instance of the application service.

12. The computer-implemented method of claim 8, further comprising:
subsequent to the descriptive model being updated to include one or more new configuration settings for a new integrated service, causing an updated user interface to be presented to a user, the updated user interface presenting the one or more new configuration settings for the new integrated service;
receiving a request to update the instance of the application service based on a specification of configuration values for the configuration settings for the plurality of integrated services including configuration values for the one or more new configuration settings for the new integrated service;
responsive to the request to update the instance of the application service, communicating to each integrated service of the plurality of integrated services an instance configuration request, the instance configuration request including specified configuration values for one or more configuration settings for the integrated service, including configuration values for one or more new configuration settings for the new integrated service;
receiving from each integrated service of the plurality of integrated services a service configuration status in response to the instance configuration request; and
storing, as an instance data record for the updated instance of the application service, the configuration status of each integrated service, the configuration values for the one or more configuration settings for each integrated service and an indicator of a version of the updated descriptive model in use at the time of the request to update the instance of the application service.

13. The computer-implemented method of claim 8, wherein a first edition of the version-controlled descriptive model specifies a first set of configuration values for a subset of the one or more configuration settings for the plurality of integrated services; and
wherein causing the user interface to be presented to the user comprises causing the user interface to present configuration values for the subset of the one or more configuration settings for the plurality of integrated services.

14. The computer-implemented method of claim 8, further comprising:
receiving a request to update the instance of the application service based on a specification of configuration values associated with a specific version of the descriptive model;
obtaining from a selected configured instance record configuration values for the one or more configuration settings of the plurality integrated services, wherein the configured instance record is selected based on the configured instance record having an indicator of a version of the descriptive model that corresponds with the specific version of the descriptive model.

15. A system comprising:
means for causing a first user interface to be presented to a user, the first user interface presenting for each integrated service of a plurality of integrated services, one or more configuration settings, wherein the one or more configuration settings for each integrated service are maintained as a version-controlled descriptive model;
means for receiving a request to instantiate an instance of a application service based on a specification of configuration values for the configuration settings for the plurality of integrated services as provided by the user via the user interface;
responsive to the request to instantiate the instance of the application service, means for communicating to each integrated service of the plurality of integrated services an instance configuration request, the instance configuration request associated with specified values for one or more configuration settings for the integrated service;
means for receiving from each integrated service of the plurality of integrated services a service configuration status in response to the instance configuration request; and
means for storing, as an instance data record for the instantiated instance of the application service, the configuration status of each integrated service, the values for the one or more configuration settings for each integrated service, and an indicator of a version of the descriptive model in use at the time of the request to instantiate the instance of the application service.

16. The system of claim 1, further comprising:
means for receiving from a first integrated service of the plurality of integrated services a service configuration status in response to the instance configuration request, the service configuration status indicating a change in service capabilities of the first integrated service;
means for generating an alert to indicate the first integrated service has reported a change in service capabilities; and
means for causing the alert to be displayed.

17. The system of claim 1, further comprising:
means for receiving from a first integrated service of the plurality of integrated services an error message in response to the instance configuration request;
means for generating an alert to indicate the first integrated service has reported the error message; and
means for causing the alert to be displayed.

18. The system of claim 1, further comprising:
subsequent to the descriptive model being updated to include one or more new configuration settings for one or more new features or functions of a first integrated service of the plurality of integrated services, means for causing an updated user interface to be presented to a user, the updated user interface presenting the one or more new configuration settings for the first integrated service;
means for receiving a request to update the instance of the application service based on a specification of values for the configuration settings for the plurality of integrated services, including configuration values for the one or more new configuration settings for the first integrated service;
responsive to the request to update the instance of the application service, means for communicating to each integrated service of the plurality of integrated services an instance configuration request, the instance configuration request including specified values for one or more configuration settings for the integrated service, including values for one or more new configuration settings for first integrated service;
means for receiving from each integrated service of the plurality of integrated services a service configuration status in response to the instance configuration request; and
means for storing, as an instance data record for the updated instance of the application service, the configuration status of each integrated service, the values for the one or more configuration settings for each integrated service and an indicator of a version of the updated descriptive model in use at the time of the request to update the instance of the application service.

19. The system of claim 1, wherein the instructions cause the system to perform additional operations comprising:
subsequent to the descriptive model being updated to include one or more new configuration settings for a new integrated service, means for causing an updated user interface to be presented to a user, the updated user interface presenting the one or more new configuration settings for the new integrated service;
means for receiving a request to update the instance of the application service based on a specification of configuration values for the configuration settings for the plurality of integrated services including configuration values for the one or more new configuration settings for the new integrated service;
responsive to the request to update the instance of the application service, means for communicating to each integrated service of the plurality of integrated services an instance configuration request, the instance configuration request including specified configuration values for one or more configuration settings for the integrated service, including configuration values for one or more new configuration settings for the new integrated service;
means for receiving from each integrated service of the plurality of integrated services a service configuration status in response to the instance configuration request; and
means for storing, as an instance data record for the updated instance of the application service, the configuration status of each integrated service, the configuration values for the one or more configuration settings for each integrated service and an indicator of a version of the updated descriptive model in use at the time of the request to update the instance of the application service.

20. The system of claim 1, wherein a first edition of the version-controlled descriptive model specifies a first set of configuration values for a subset of the one or more configuration settings for the plurality of integrated services; and
wherein causing the user interface to be presented to the user comprises causing the user interface to present configuration values for the subset of the one or more configuration settings for the plurality of integrated services.
